(19) United States
(12) Patent Application Publication
(10) Pub. No.: US 2024/0391590 A1
(43) Pub. Date: Nov. 28, 2024

(54) ENTRY WAY SYSTEM FOR AN INTERNAL CABIN OF AN AIRCRAFT

(71) Applicant: THE BOEING COMPANY, Arlington, VA (US)

(72) Inventors: Thomas Eaton, Los Angeles, CA (US); Zixuan Weng, Los Angeles, CA (US); Victor Carlioz, Los Angeles, CA (US); Matthew Cleary, Los Angeles, CA (US); Andrew Greenbaum, Los Angeles, CA (US); Matteo Broccolo, Los Angeles, CA (US); Claire Nelsen, Los Angeles, CA (US)

(73) Assignee: THE BOEING COMPANY, Arlington, VA (US)

(21) Appl. No.: 18/591,236

(22) Filed: Feb. 29, 2024

Related U.S. Application Data
(60) Provisional application No. 63/504,473, filed on May 26, 2023.

(51) Int. Cl. B64D 11/00

(52) U.S. Cl. CPC B64D 11/00

(57) ABSTRACT

An aircraft including an internal cabin having an egress path connecting to one or more entry doors, and an entry way system within the internal cabin. The entry way system includes a first monument and a second monument. The egress path extends between the first monument and the second monument.

### CROSS-REFERENCE TO RELATED APPLICATIONS

This application is a non-provisional conversion of, and claims priority to, U.S. Provisional Patent Application No. 63/504,473, filed May 26, 2023, which is incorporated by reference in its entirety.

### FIELD OF THE DISCLOSURE

Examples of the present disclosure generally relate to an entry way system for an internal cabin of an aircraft.

### BACKGROUND OF THE DISCLOSURE

Vehicles such as commercial aircraft are used to transport passengers between various locations. A typical aircraft includes an internal cabin having seats for passengers.

As can be appreciated, the space within an internal cabin is limited. Airline operators seek to provide comfortable and inviting areas for passengers within the limited space of an internal cabin. However, the limited space within the internal cabin poses challenges to providing various types of lounge areas. In particular, airline operators are typically hesitant to provide large lounge areas, which would otherwise take up space that can otherwise be used for revenue-generating passenger seats.

### SUMMARY OF THE DISCLOSURE

Certain examples of the present disclosure provide an entry way system for an internal cabin of a vehicle (for example, a commercial aircraft). The entry way system includes a first monument, and a second monument configured to be spaced from the first monument by an egress path configured to connect to one or more entry doors.

In at least one example, the first monument and the second monument are configured extend to and between a floor and a ceiling of the internal cabin.

In at least one example, the first monument and the second monument are configured to be disposed between portions of two aisles within the internal cabin.

In at least one example, one or both of the first monument and the second monument includes one or more electronic displays. The one or more electronic displays can include a transparent organic light emitting diode (OLED) monitor.

In at least one example, the first monument comprises one or more of one or more shelves, one or more lighting assemblies, a countertop, one or more storage drawers, a trash bin, a refreshment retainer, and/or a literature pocket.

In at least one example, the second monument includes one or more of one or more lighting assemblies, a lounge support, and/or a shelf.

In at least one example, the entry way system includes one or more electrical components, and a control unit in communication with the one or more electrical components. The control unit is configured to control operation of the one or more electrical components.

Certain examples of the present disclosure provide a vehicle, such as an aircraft, including an internal cabin, and an entry way system within the internal cabin, as described herein.

### BRIEF DESCRIPTION OF THE DRAWINGS

FIG. 1 illustrates a perspective front view of an aircraft, according to an example of the present disclosure.

FIG. 2 illustrates a perspective interior view of an internal cabin of an aircraft, according to an example of the present disclosure.

FIG. 3 illustrates a perspective interior view of an internal cabin of an aircraft viewed from an entry way looking aft, according to an example of the present disclosure.

FIG. 4 illustrates a perspective view of an entry way system from a first side, according to an example of the present disclosure.

FIG. 5 illustrates a perspective front view of a first monument, according to an example of the present disclosure.

FIG. 6 illustrates a perspective rear view of a second monument, according to an example of the present disclosure.

FIG. 7 illustrates a top plan view of the entry way system.

FIG. 8 illustrates a lateral view of the entry way system from the first side.

FIG. 9 illustrates a lateral view of the entry way system from a second side (opposite from the first side).

FIG. 10 illustrates a perspective partial view of an interior of the second monument.

FIG. 11 illustrates a perspective partial view of an interior of the first monument having storage drawers in closed positions.

FIG. 12 illustrates a perspective partial view of an interior of the first monument having a storage drawer in in an open position.

FIG. 13 illustrates a perspective partial view of an interior of the first monument having trays supported on a countertop.

FIG. 14 illustrates a perspective lateral, rear view of the entry way system from the first side.

FIG. 15 illustrates a perspective lateral, front view of the entry way system from the second side.

FIG. 16 illustrates a perspective lateral, rear view of the entry way system from the first side.

FIG. 17 illustrates a block diagram of the entry way system, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Certain examples of the present disclosure provide an entry way system for an internal cabin of a vehicle. The entry way system includes a first monument and a second monument. An egress path is configured to extend through the entry way system between the first monument and the second monument.

In at least one example, a vehicle (such as a commercial aircraft) includes an internal cabin having an egress path connecting to one or more entry doors. An entry way system is within the internal cabin. The entry way system includes a first monument and a second monument. The egress path extends through the entry way system between the first monument and the second monument. The first monument and the second monument can extend to and between a floor and a ceiling of the internal cabin. One or both of the first monument and the second monument can include one or more electronic displays. The first monument or the second monument can include one or more shelves, one or more lighting assemblies, a countertop, one or more storage drawers, a trash bin, a refreshment retainer, and/or a literature pocket. The first monument or the second monument can include one or more lighting assemblies, a lounge support, and/or a shelf.

Examples of the present disclosure provide an entry way system for an internal cabin of a vehicle, such as a commercial aircraft. The entry way system provides a door-two entry way assembly and configuration that includes one or more monuments, which can extend floor-to-ceiling. The monument(s) can include an electronic display, such as a transparent organic light emitting diode (OLED) monitor, which can be controllable, such as via a control unit. Control of the electronic display can be based on phases of flight (for example, the display can be transparent for viewing into the internal cabin). In at least one example, the entry way system includes one or more speakers, a water faucet, lighting, storage compartments, and the like. The entry way system can be adapted based on different settings. The entry way system can be selectively adapted based on different modes during phases of flight. For example, the entry way system can provide a welcome center and wayfinding aid upon boarding, happy hour center, rest time during flight, and also a wayfinding aid during disembarking. The different modes can be provided through lighting control, audio control, and displayed content control. The entry way system can be disposed at an entrance path, such as between two doors that lead into the internal cabin.

In at least one example, the entry way systems described herein are specifically sized, shaped, and designed to fit within a limited space of an internal cabin of an aircraft, such as within an entry way between entry doors. In this manner, the entry way systems do not take up space that is used for passenger seating.

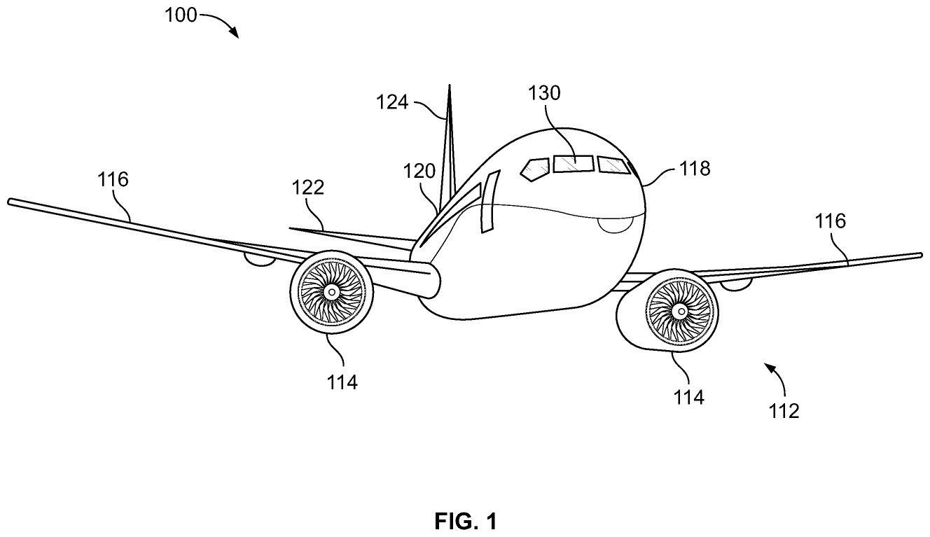

FIG. 1 illustrates a perspective front view of an aircraft 100, according to an example of the present disclosure. The aircraft 100 includes a propulsion system 112 that includes engines 114, for example. Optionally, the propulsion system 112 can include more engines 114 than shown. The engines 114 are carried by wings 116 of the aircraft 100. In other examples, the engines 114 may be carried by a fuselage 118 and/or an empennage 120. The empennage 120 can also support horizontal stabilizers 122 and a vertical stabilizer 124.

The fuselage 118 of the aircraft 100 defines an internal cabin 130, which includes a flight deck or cockpit, one or more work sections (for example, galleys, personnel carry-on baggage areas, and the like), one or more passenger sections (for example, first class, business class, and coach sections), one or more lavatories, and/or the like.

Alternatively, instead of an aircraft, examples of the present disclosure may be used with various other vehicles, such as automobiles, buses, locomotives and train cars, watercraft, and the like.

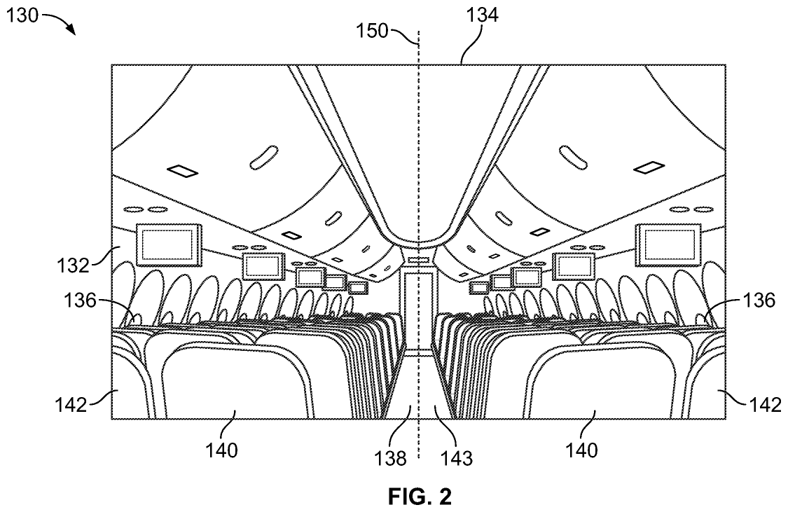

FIG. 2 illustrates a perspective interior view of an internal cabin 130 of an aircraft, according to an example of the present disclosure. The internal cabin 130 includes outboard walls 132 and a ceiling 134. Windows 136 may be formed within the outboard walls 132. A floor 138 supports rows of seats 140. As shown in FIG. 2, a row 142 may include three seats 140 on either side of an aisle 143. However, the row 142 may include more or less seats 140 than shown. Additionally, the internal cabin 130 may include more aisles than shown.

As used herein, the term “outboard” means a position that is further away from a central longitudinal plane 150 of the internal cabin 130 as compared to another component. The term “inboard” means a position that is closer to the central longitudinal plane 150 of the internal cabin 130 as compared to another component.

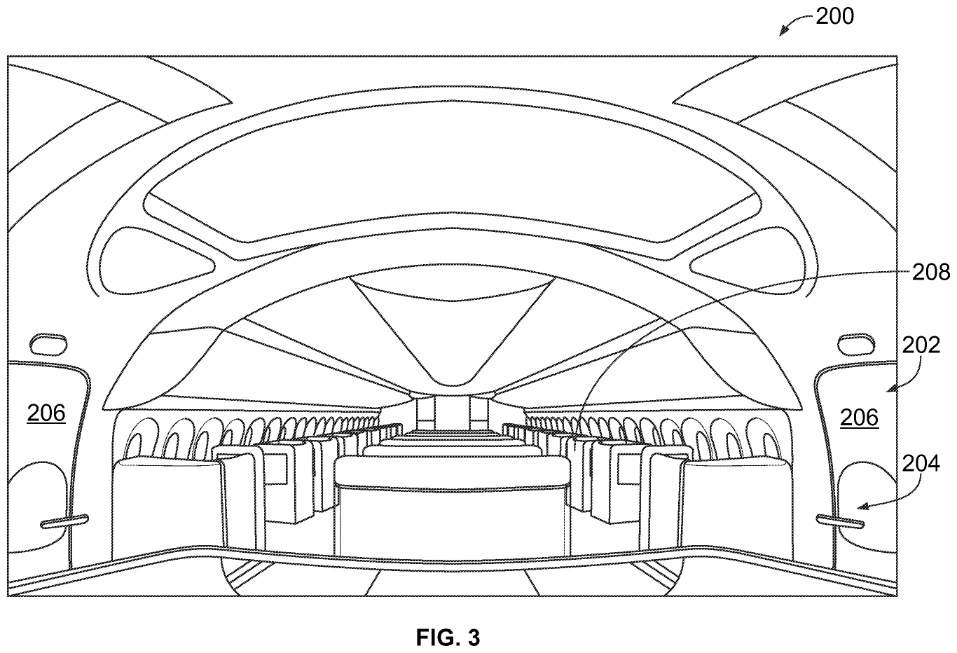

FIG. 3 illustrates a perspective interior view of an internal cabin 200 of an aircraft viewed from an entry way 202 looking aft (that is, toward an aft section of the aircraft), according to an example of the present disclosure. The entry way 202 includes an egress path 204 that extends to one or more entry doors 206. As shown, the egress path 204 extends between two entry doors 206 at opposite sides of the internal cabin 200. One or more aisles 208 connect to the egress path 204. For example, two aisles 208 can connect to the egress path 204. The egress path 204 can be perpendicular to the aisles 208. For example, the egress path 204 can be a cross path that is perpendicular to the aisles 208, which extend along a length of the internal cabin 200. As described herein, an entry way system is configured to be disposed in the entry way 202.

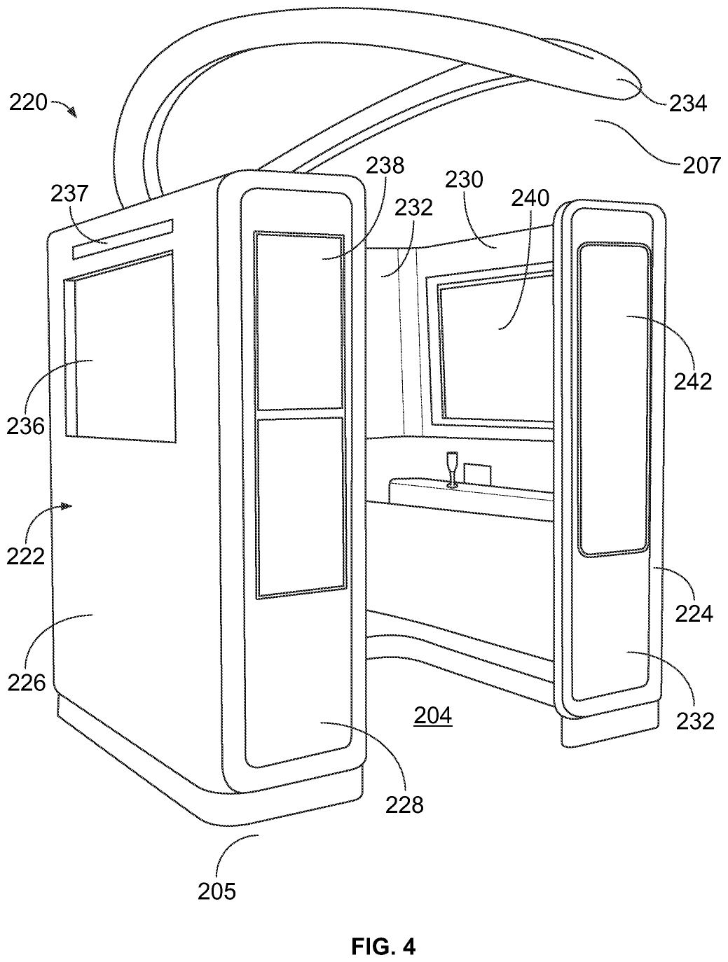

FIG. 4 illustrates a perspective view of an entry way system 220 from a first side, according to an example of the present disclosure. The entry way system 220 includes a first monument 222 spaced apart from a second monument 224. Optionally, the entry way system 220 can include only the first monument 222, or the second monument 224.

Referring to FIGS. 3 and 4, the entry way system 220 is disposed between portions of two aisles 208, and the egress path 204 passes between the first monument 222 and the second monument 224. A length, a width, and a height of the entry way system 220 can each be greater or less than shown. In at least one example, the first monument 222 and the second monument 224 extend from a floor 205 to a ceiling 207 within the internal cabin 200.

The first monument 222 includes an aft wall 226 connected to lateral walls 228. The aft wall 226 faces a passenger seating area. The second monument 224 includes a fore wall 230 connected to lateral walls 232. The fore wall 230 faces one or more or of a forward passenger seating area, a flight deck, and/or the like. Optionally, the entry way system 220 can be reversed, such that that the first monument 222 is forward in relation to the second monument 224 (in which case, the aft wall 226 would be a fore wall, and the fore wall 230 would be an aft wall).

As shown, a lighting assembly 234 can be disposed above the entry way system 220, such as over the egress path 204. Optionally, the light assembly 234 may not be above the egress path 204.

The first monument 222 can include a display 236 disposed on the aft wall 226. The display 236 can be an electronic screen, monitor, television, and/or the like. In at least one example, the display 236 is an OLED screen (such as a 55″ transparent OLED monitor) mounted within a recess of the aft wall 226. In this manner, the display 236 can extend between and through front and rear surfaces of the aft wall 226. Optionally, a display 236 can be mounted onto a surface of the aft wall 226, instead of being mounted within a recess. For example, a first display can be mounted to an interior surface of the aft wall 226 and/or a second display can be mounted to an exterior surface of the aft wall 226.

The first monument 222 can also include one or more displays 238, such as electronic screens, monitors (such as 27″ 5K monitors), televisions, and/or the like, secured to outer surfaces of one or both of the lateral walls 228. Optionally, the first monument 222 may not include one or more of the display 236 and/or the displays 238. In at least one example, the display 236 and/or the displays 238 can be signs, instead of electronic screens.

A speaker 237 can be mounted above, below, and/or to a side of the display 236. In at least one example, the display 236 includes the speaker 237. Optionally, the speaker(s) can be located at various other areas. The speaker(s) 237 can be directional speakers. Optionally, the entry way system 220 may not include a speaker.

Similarly, the second monument 224 can include a display 240, such as an electronic screen, monitor, television, and/or the like. In at least one example, the display 240 is an OLED screen mounted within a recess of the fore wall 230. In this manner, the display 240 can extend between and through front and rear surfaces of the fore wall 230. Optionally, a display 240 can be mounted onto a surface of the fore wall 230, instead of being mounted within a recess. For example, a first display can be mounted to an interior surface of the fore wall 230 and/or a second display can be mounted to an exterior surface of the fore wall 230.

The second monument 224 can also include one or more displays 242, such as electronic screens, monitors, televisions, and/or the like, secured to outer surfaces of one or both of the lateral walls 232. Optionally, the second monument 224 may not include one or more of the display 240 and/or the displays 242. In at least one example, the display 240 and/or the displays 242 can be signs, instead of electronic screens.

The displays 236 and 240 can be configured for general entertainment, announcements, and visibility therethrough (for example, transparent OLED monitors).

As described herein, the entry way system 220 is configured to be disposed within an internal cabin 200 (shown in FIG. 3) of a vehicle, such as a commercial aircraft. The entry way system 220 includes the first monument 222 and the second monument 224. The second monument 224 is configured to be spaced from the first monument 222 by the egress path 204, which connects to one or more entry doors 206 (shown in FIG. 3).

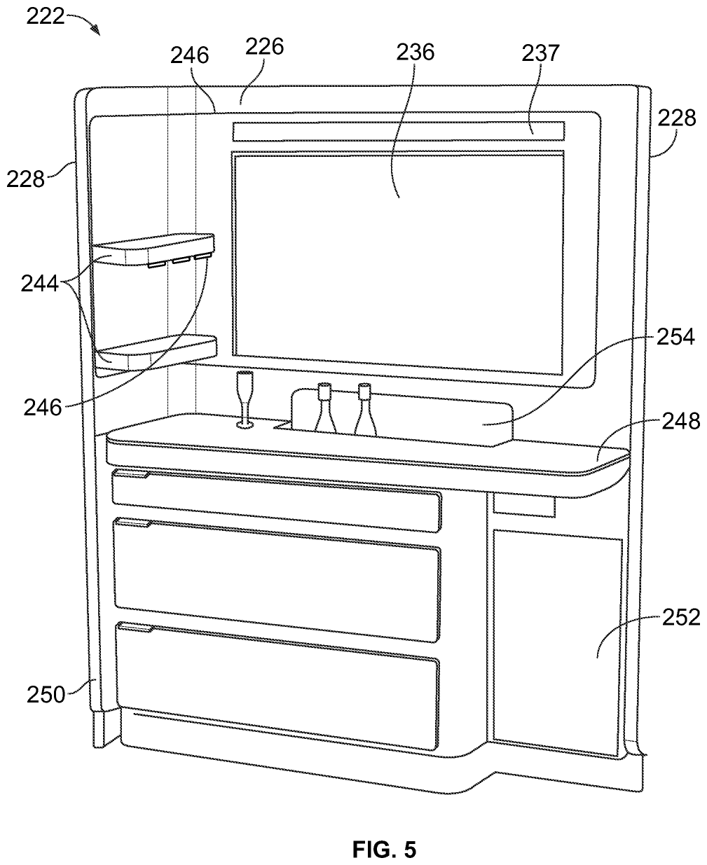

FIG. 5 illustrates a perspective front view of the first monument 222, according to an example of the present disclosure. As shown, in at least one example, the display 236 passes through the aft wall 226. Optionally, two separate displays can be mounted on opposite surfaces of the aft wall 226. In at least one example, the first monument 222 includes shelves 244, such as can be secured to interior surfaces of one or more both lateral walls 228. Lighting assemblies 246 can be secured on and/or within the lateral walls 228, and/or the aft wall 226. A countertop 248 can extend along an interior of the aft wall 226, such as between the lateral walls 228. One or more storage drawers 250 are movably secured underneath the countertop 248. Further, a trash bin 252 can be mounted underneath the countertop 248. A refreshment retainer 254 can be disposed within the countertop 248. The refreshment retainer 254 can be a champagne bucket, for example.

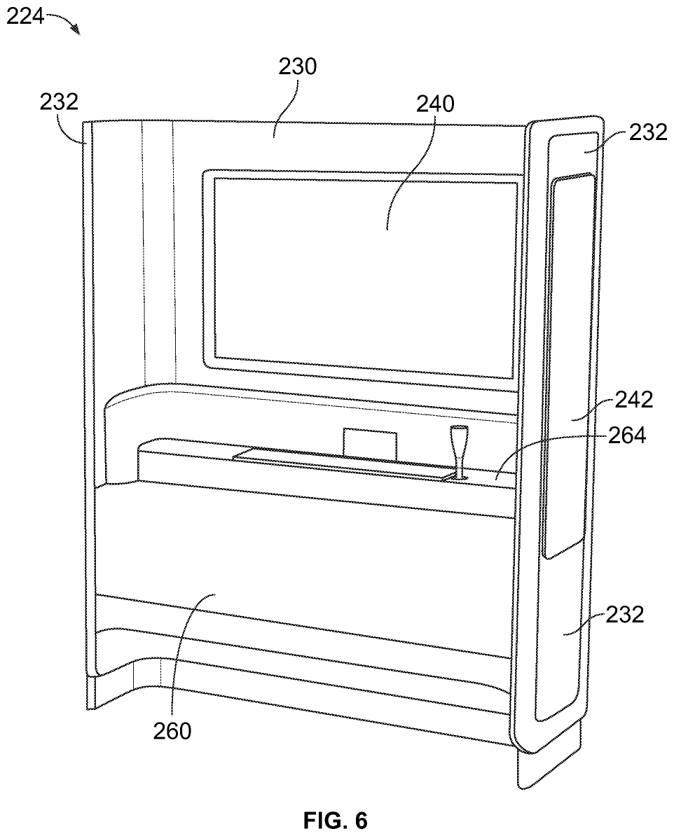

FIG. 6 illustrates a perspective rear view of the second monument 224, according to an example of the present disclosure. As shown, the display 240 passes through the fore wall 230. Optionally, two separate displays can be mounted on opposite surfaces of the fore wall 230. In at least one example, the second monument 224 includes a lounge support 260 extending along the fore wall 230 between the lateral walls 232. The lounge support 260 can be cushioned, and is configured to allow passengers to engage, such as by comfortably leaning against the lounge support 260. A shelf 264 can be disposed above the lounge support 260. The shelf 264 can be secured to the fore wall 230 and/or one or both of the lateral walls 232.

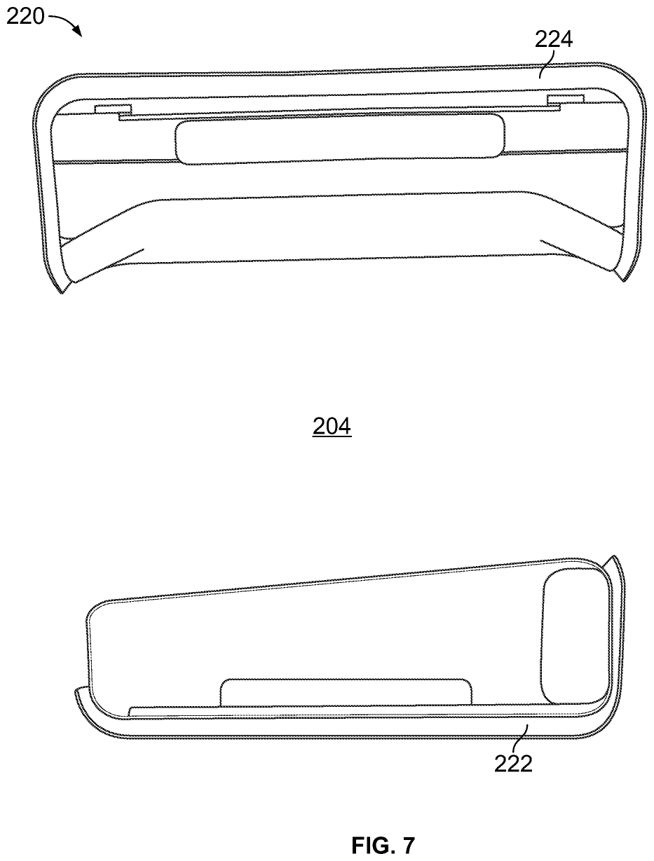

FIG. 7 illustrates a top plan view of the entry way system 220. As shown, the first monument 222 and the second monument 224 are on opposite sides of the egress path 204.

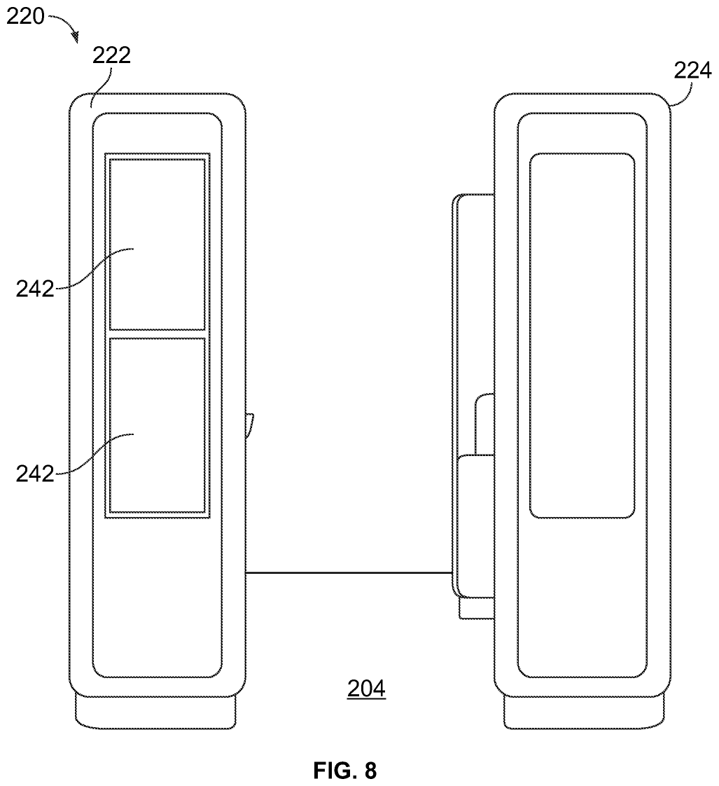

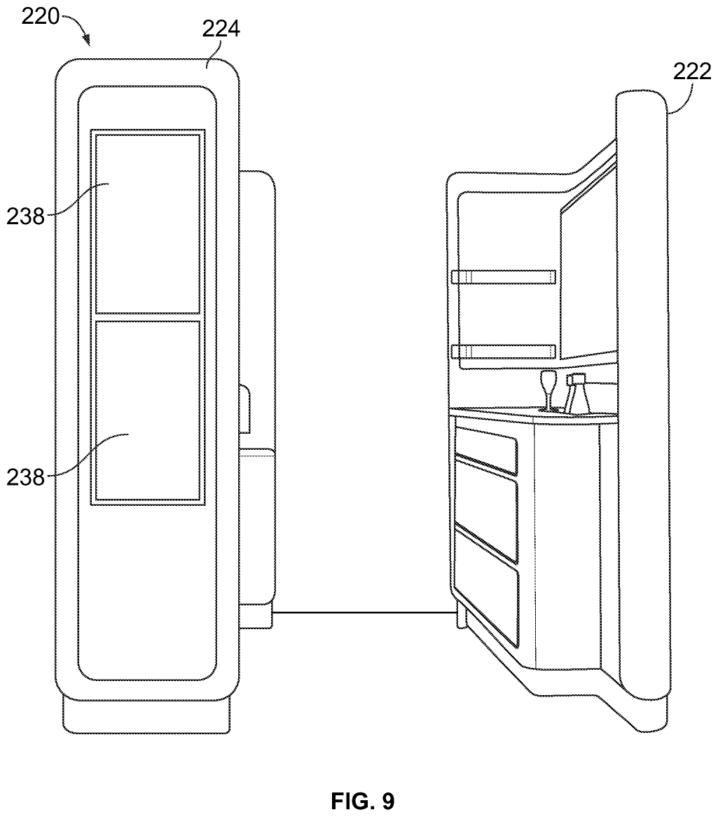

FIG. 8 illustrates a lateral view of the entry way system 220 from the first side. FIG. 9 illustrates a lateral view of the entry way system 220 from a second side (opposite from the first side). Referring to FIGS. 8 and 9, in at least one example, as passengers enter the internal cabin into the egress path, the displays 238 can be operated to provide welcoming messages, wayfinding information, graphics, videos, and/or the like.

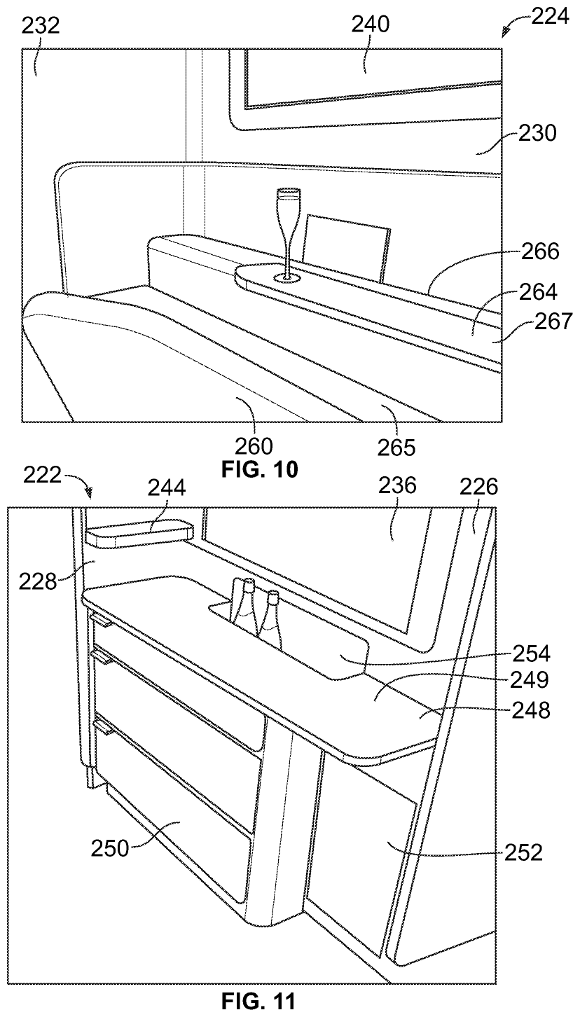

FIG. 10 illustrates a perspective partial view of an interior of the second monument 224. As shown, a literature pocket 266 can be provided in the shelf 264. The shelf 264 can include a lower level 265 extending inwardly toward the fore wall 230 from the lounge support 260. The shelf 264 can further include an upper level 267 extending upwardly and inwardly toward the fore wall 230 from the lower level 265. Optionally, the shelf 264 can include only a single level.

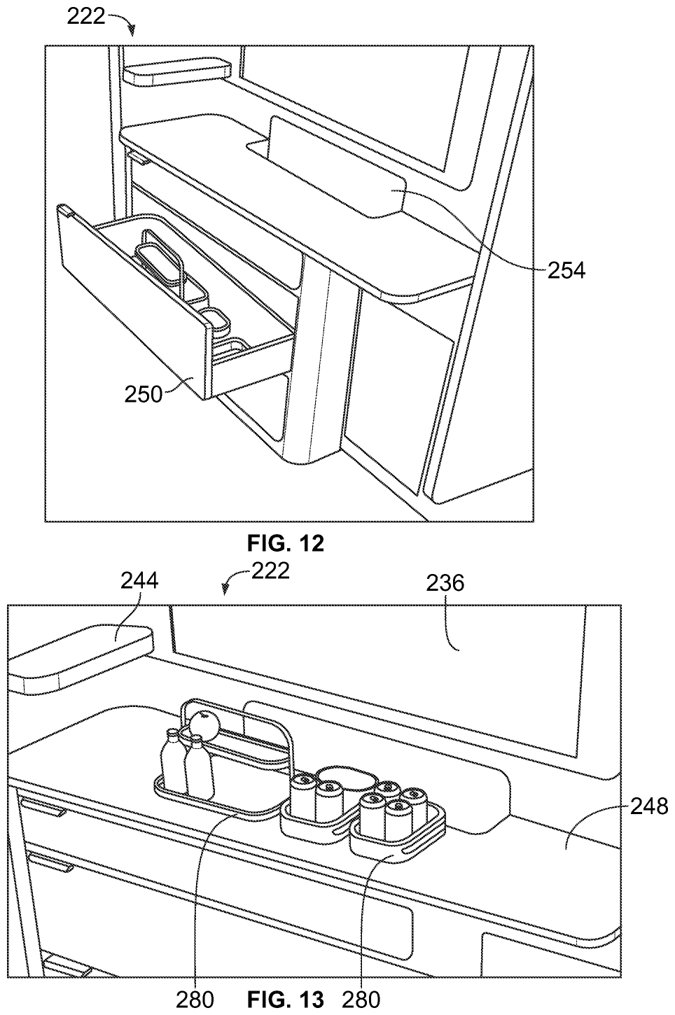

FIG. 11 illustrates a perspective partial view of an interior of the first monument 222 having storage drawers 250 in closed positions. FIG. 12 illustrates a perspective partial view of an interior of the first monument 222 having a storage drawer in 250 in an open position. FIG. 13 illustrates a perspective partial view of an interior of the first monument 222 having trays 280 supported on a countertop 248. Referring to FIGS. 11-13, the refreshment retainer 254 can extend below an upper surface 249 of the countertop 248. The storage drawers 250 can be moved between open and closed positions. The first monument 222 can have fewer or more storage drawers 250 than shown. Optionally, the first monument 222 may not include any storage drawers.

Trays 280 can be supported on the countertop 248. The trays 280 can be stored in the storage drawers 250. The trays 280 can be used to retain beverages, food items, or the like.

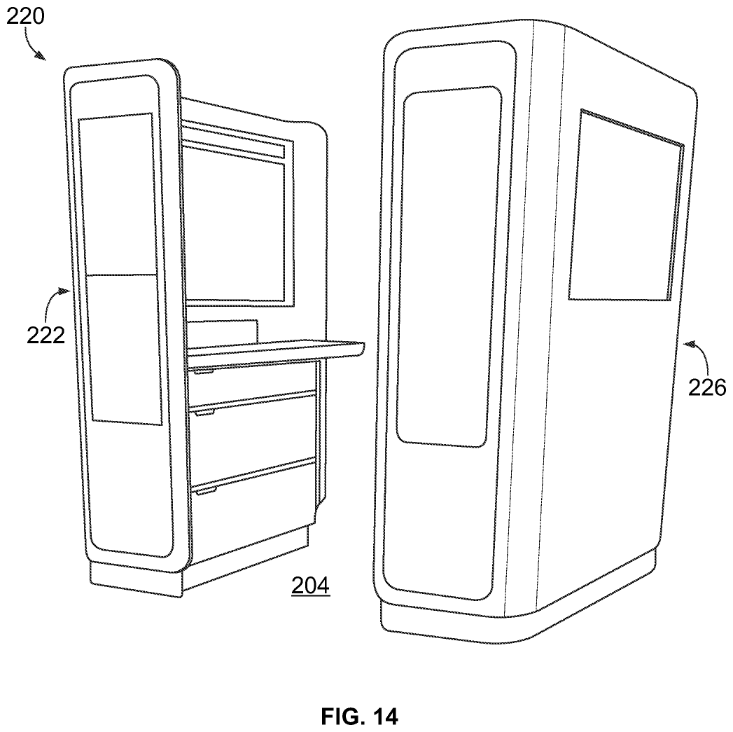

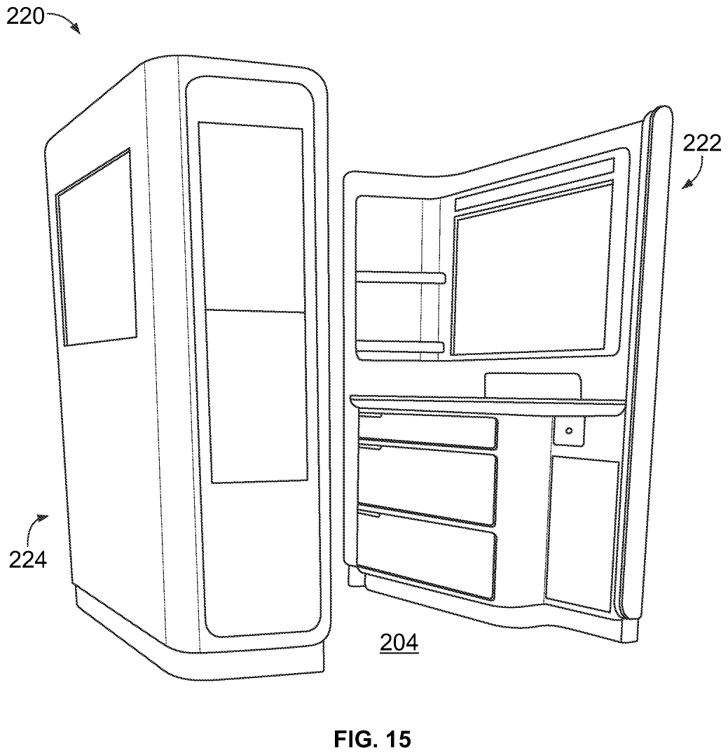

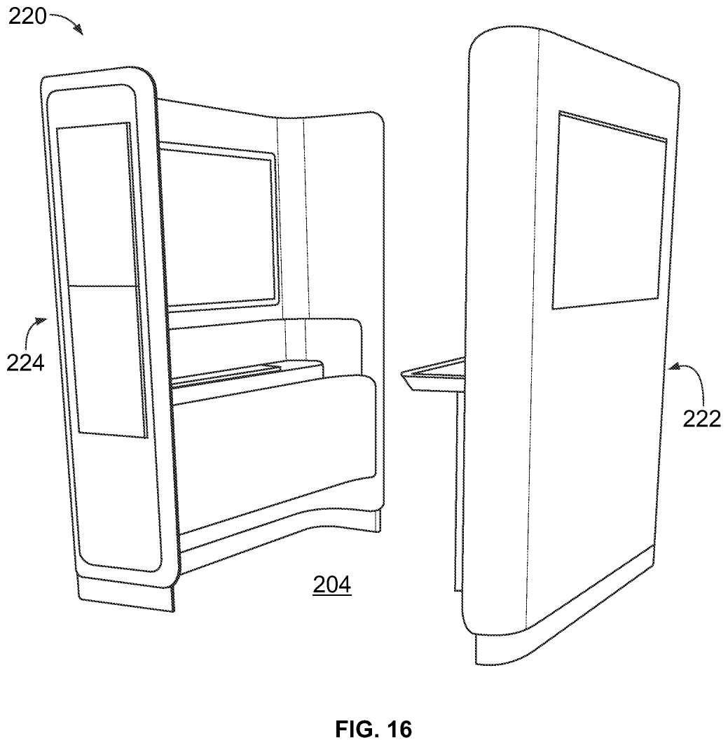

FIG. 14 illustrates a perspective lateral, rear view of the entry way system 220 from the first side. FIG. 15 illustrates a perspective lateral, front view of the entry way system 220 from the second side. FIG. 16 illustrates a perspective lateral, rear view of the entry way system 220 from the first side. As noted, the entry way system 220 can be reversed, such that the rear view becomes a front view; the front view becomes a rear view; the first side becomes the second side; the second side becomes the first side; and/or the like, The orientations shown and described are merely exemplary, and can be changed, as desired.

Further, as described, the entry way system 220 includes the first monument 222 and the second monument 224. Optionally, the entry way system 220 can include only the first monument 222 or the second monument 224.

The entry way system 220 can be sized and shaped differently than shown. For example, the entry way system 220 can be configured to conform to a shape of an egress path, which can include angled or curved portions. Further, the entry way system 220 can also include moveable shelves (such as can pivot or slide into different positions), footrests, seats, and the like.

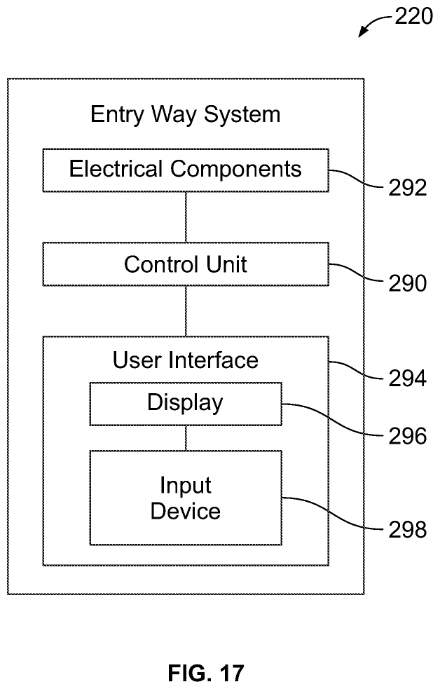

FIG. 17 illustrates a block diagram of the entry way system 220, according to an example of the present disclosure. Referring to FIGS. 1-17, the entry way system 220 can further include a control unit 290 in communication with electrical components 292, such as through one or more wired or wireless connections. Examples of the electrical components 292 include electronic displays (for example, the displays 236, 238, 240, 242) speakers (for example, the speaker 237), lighting systems and assemblies (such as the lighting assemblies 234 and 246), and the like. In at least one example, the control unit 290 is configured to control operation of the electrical components 292.

In at least one example, the control unit 290 is also in communication with a user interface 294, such as through one or more wired or wireless connections. The user interface 294 includes a display 296 and an input device 298. The user interface 294 can be operated by an individual to select various operational aspects of the electrical components 292, as controlled by the control unit 290.

In at least one example, the display 296 is an electronic device configured to electronically show images, videos, text, and/or the like. The display 296 can be a monitor, screen, television, touchscreen, and/or the like. The input device 298 can include a keyboard, mouse, stylus, touchscreen interface (that is, the input device 298 can be integral with the display 296), and/or the like. The display 296 is configured to show visual graphics, videos, text, and/or the like.

The control unit 290 can be disposed within the entry way system 220, such as on or within the first monument 222 or the second monument 224. For example, the control unit 290 and the user interface 294 can be part of a computer workstation within the first monument 222 or the second monument 224. As another example, the control unit 290 and/or the user interface 294 can be part of a handheld device, such as an electronic tablet, a smartphone, or the like. As a further example, the computer workstation can be disposed inside one of the storage drawers 250. As another example, the control unit 290 and/or the user interface 294 can be disposed outside of the first monument 222 and the second monument 224, such as at a different monument (for example, a galley, an attendant workstation, or the like). Optionally, the entry way system 220 may not include a control unit.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 290 may be or include one or more processors that are configured to control operation, as described herein.

The control unit 290 is configured to execute a set of instructions that are stored in one or more data storage units or elements (such as one or more memories), in order to process data. For example, the control unit 290 may include or be coupled to one or more memories. The data storage units may also store data or other information as desired or needed. The data storage units may be in the form of an information source or a physical memory element within a processing machine.

The set of instructions may include various commands that instruct the control unit 290 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 290. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 290 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-17, the entry way system 220 can be configured to be selectively adapted, based on different phases of flight. For example, during boarding, the control unit 290 can operate one or more electronic components 292, such as electronic displays and lighting assemblies, to provide welcoming settings, wayfinding aids, and/or the like. As noted, the entry way system 220 can include one or more lighting system and/or assemblies, such as on and/or within the first monument 222 and/or the second monument 224. The lighting displays and assemblies can be operated by the control unit 290 to provide various mood settings, which can be coordinated with cabin lighting.

The control unit 290 can coordinate the various displays, lighting systems and assemblies, speaker(s), and/or the like to provide adaptable graphics, videos, text, sounds, lighting, and/or the like throughout various phases of flight. In at least example, OLED displays can be selectively switched between transparent modes and opaque modes, thereby providing a virtual curtain, which can be selectively used to provide privacy, improve image quality on the displays, and/or the like.

Further, the disclosure comprises examples according to the following clauses:

Clause 1. An entry way system for an internal cabin of a vehicle, the entry way system comprising:
a first monument; and
a second monument configured to be spaced from the first monument by an egress path configured to connect to one or more entry doors.

Clause 2. The entry way system of Clause 1, wherein the first monument and the second monument are configured extend to and between a floor and a ceiling of the internal cabin.

Clause 3. The entry way system of Clauses 1 or 2, wherein the first monument and the second monument are configured to be disposed between portions of two aisles within the internal cabin.

Clause 4. The entry way system of any of Clauses 1-3, wherein one or both of the first monument and the second monument includes one or more electronic displays.

Clause 5. The entry way system of Clause 4, wherein the one or more electronic displays comprise a transparent organic light emitting diode (OLED) monitor.

Clause 6. The entry way system of any of Clauses 1-5, wherein the first monument comprises one or more of:
one or more shelves;
one or more lighting assemblies;
a countertop;
one or more storage drawers;
a trash bin;
a refreshment retainer; or
a literature pocket.

Clause 7. The entry way system of Clause 6, wherein the first monument comprises:
the one or more shelves;
the one or more lighting assemblies;
the countertop;
the one or more storage drawers;
the trash bin;
the refreshment retainer; and
the literature pocket.

Clause 8. The entry way system of any of Clauses 1-7, wherein the second monument comprises one or more of:
one or more lighting assemblies;
a lounge support; or
a shelf.

Clause 9. The entry way system of Clause 8, wherein the second monument comprises:
the one or more lighting assemblies;
the lounge support; and
the shelf.

Clause 10. The entry way system of any of Clauses 1-9, further comprising:
one or more electrical components; and
a control unit in communication with the one or more electrical components, wherein the control unit is configured to control operation of the one or more electrical components.

Clause 11. An aircraft comprising:
an internal cabin having an egress path connected to one or more entry doors; and
an entry way system within the internal cabin, wherein the entry way system
   a first monument; and
   a second monument spaced from the first monument by the egress path, wherein the egress path extends through the entry way system between the first monument and the second monument.

Clause 12. The aircraft of Clause 11, wherein the first monument and the second monument extend to and between a floor and a ceiling of the internal cabin.

Clause 13. The aircraft of Clauses 11 or 12, wherein the first monument and the second monument are disposed between portions of two aisles within the internal cabin.

Clause 14. The aircraft of any of Clauses 11-13, wherein one or both of the first monument and the second monument includes one or more electronic displays.

Clause 15. The aircraft of Clause 14, wherein the one or more electronic displays comprise a transparent organic light emitting diode (OLED) monitor.

Clause 16. The aircraft of any of Clauses 11-15, wherein the first monument comprises one or more of:
one or more shelves;
one or more lighting assemblies;
a countertop;
one or more storage drawers;
a trash bin;
a refreshment retainer; or
a literature pocket.

Clause 17. The aircraft of Clause 16, wherein the first monument comprises:
the one or more shelves;
the one or more lighting assemblies;
the countertop;
the one or more storage drawers;
the trash bin;
the refreshment retainer; and
the literature pocket.

Clause 18. The aircraft of any of Clauses 11-17, wherein the second monument comprises one or more of:
one or more lighting assemblies;
a lounge support; or
a shelf.

Clause 19. The aircraft of Clause 18, wherein the second monument comprises:
the one or more lighting assemblies;
the lounge support; and
the shelf.

Clause 20. The aircraft of any of Clauses 11-19, further comprising:
one or more electrical components; and
a control unit in communication with the one or more electrical components, wherein the control unit is configured to control operation of the one or more electrical components.

Clause 21. An aircraft comprising:
an internal cabin having an egress path connected to one or more entry doors, and two aisles connected to the egress path; and
an entry way system within the internal cabin, wherein the entry way system
a first monument extending between a floor and a ceiling of the internal cabin, wherein the first monument is disposed portions of the two aisles, and wherein the first monument comprises:
   a first transparent organic light emitting diode (OLED) monitor;
   one or more shelves;
   one or more lighting assemblies;
   a countertop;
   one or more storage drawers;
   a trash bin;
   a refreshment retainer; and
   a literature pocket; and
a second monument spaced from the first monument by the egress path, wherein the second monument extends between the floor and the ceiling, wherein the second monument is disposed between the portions of the two aisles, wherein the egress path extends through the entry way system between the first monument and the second monument, and wherein the second monument comprises:
   a second transparent OLED monitor;
   one or more lighting assemblies;
   a lounge support; and
   a shelf.

As described herein, examples of the present disclosure provide comfortable and inviting entry way systems, such as within internal cabins of vehicles. In at least one example, the entry way systems are specifically sized, shaped, and designed to fit within a limited space of an internal cabin of an aircraft, such as within an entry way, without encroaching on space used for passenger seating.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An entry way system for an internal cabin of a vehicle, the entry way system comprising:
a first monument; and
a second monument configured to be spaced from the first monument by an egress path configured to connect to one or more entry doors.

2. The entry way system of claim 1, wherein the first monument and the second monument are configured extend to and between a floor and a ceiling of the internal cabin.

3. The entry way system of claim 1, wherein the first monument and the second monument are configured to be disposed between portions of two aisles within the internal cabin.

4. The entry way system of claim 1, wherein one or both of the first monument and the second monument includes one or more electronic displays.

5. The entry way system of claim 4, wherein the one or more electronic displays comprise a transparent organic light emitting diode (OLED) monitor.

6. The entry way system of claim 1, wherein the first monument comprises one or more of:
one or more shelves;
one or more lighting assemblies;
a countertop;
one or more storage drawers;
a trash bin;
a refreshment retainer; or
a literature pocket.

7. The entry way system of claim 6, wherein the first monument comprises:
the one or more shelves;
the one or more lighting assemblies;
the countertop;
the one or more storage drawers;
the trash bin;
the refreshment retainer; and
the literature pocket.

8. The entry way system of claim 1, wherein the second monument comprises one or more of:
one or more lighting assemblies;
a lounge support; or
a shelf.

9. The entry way system of claim 8, wherein the second monument comprises:
the one or more lighting assemblies;
the lounge support; and
the shelf.

10. The entry way system of claim 1, further comprising:
one or more electrical components; and
a control unit in communication with the one or more electrical components, wherein the control unit is configured to control operation of the one or more electrical components.

11. An aircraft comprising:
an internal cabin having an egress path connected to one or more entry doors; and
an entry way system within the internal cabin, wherein the entry way system comprises:
a first monument; and
a second monument spaced from the first monument by the egress path, wherein the egress path extends through the entry way system between the first monument and the second monument.

12. The aircraft of claim 11, wherein the first monument and the second monument extend to and between a floor and a ceiling of the internal cabin.

13. The aircraft of claim 11, wherein the first monument and the second monument are disposed between portions of two aisles within the internal cabin.

14. The aircraft of claim 11, wherein one or both of the first monument and the second monument includes one or more electronic displays.

15. The aircraft of claim 14, wherein the one or more electronic displays comprise a transparent organic light emitting diode (OLED) monitor.

16. The aircraft of claim 11, wherein the first monument comprises one or more of:
one or more shelves;
one or more lighting assemblies;
a countertop;
one or more storage drawers;
a trash bin;
a refreshment retainer; or
a literature pocket.

17. The aircraft of claim 16, wherein the first monument comprises:
the one or more shelves;
the one or more lighting assemblies;
the countertop;
the one or more storage drawers;
the trash bin;
the refreshment retainer; and
the literature pocket.

18. The aircraft of claim 11, wherein the second monument comprises one or more of:
one or more lighting assemblies;
a lounge support; or
a shelf.

19. The aircraft of claim 18, wherein the second monument comprises:
the one or more lighting assemblies;
the lounge support; and
the shelf.

20. The aircraft of claim 11, further comprising:
one or more electrical components; and
a control unit in communication with the one or more electrical components, wherein the control unit is configured to control operation of the one or more electrical components.

21. An aircraft comprising:
an internal cabin having an egress path connected to one or more entry doors, and two aisles connected to the egress path; and
an entry way system within the internal cabin, wherein the entry way system comprises:
a first monument extending between a floor and a ceiling of the internal cabin, wherein the first monument is disposed portions of the two aisles, and wherein the first monument comprises:
a first transparent organic light emitting diode (OLED) monitor;
one or more shelves;
one or more lighting assemblies;
a countertop;
one or more storage drawers;
a trash bin;
a refreshment retainer; and
a literature pocket; and
a second monument spaced from the first monument by the egress path, wherein the second monument extends between the floor and the ceiling, wherein the second monument is disposed between the portions of the two aisles, wherein the egress path extends through the entry way system between the first monument and the second monument, and wherein the second monument comprises:
a second transparent OLED monitor;
one or more lighting assemblies;
a lounge support; and
a shelf.
